(19) United States
(12) Patent Application Publication
(10) Pub. No.: US 2002/0076019 A1
(43) Pub. Date: Jun. 20, 2002

(54) Cash calling system

(76) Inventors: Vivek Tandon, Westfield (GB); Will Stackhouse, Redondo Beach, CA (US)

Correspondence Address: Thomas N. Giaccherini, Anglin & Giaccherini, Post Office Box 1146, Carmel Valley, CA, 93924, US

(21) Appl. No.: 09/745,015

(22) Filed: Dec. 20, 2000

(51) Int. Cl. H04M 15/00; H04M 17/00

(52) U.S. Cl. 379/114.14; 379/144.01; 379/114.13

(57) ABSTRACT

Methods and apparatus for placing and receiving voice calls using the conventional telephone network or the Internet are disclosed. A caller initiates a call by lifting a handset and dialing a toll-free telephone number. The call is routed over through a local telephone switch or through an Internet Service Provider. A credit or payment is issued to the caller for each minute the call continues. Brief commercial messages are played to the participants of the call to promote goods or services offered by a sponsor. In an alternative embodiment of the invention, a Speech Recognition Engine deploys a sponsor's precisely targeted promotion when key words spoken during the call are detected.

### FEDERALLY SPONSORED RESEARCH OR DEVELOPMENT

None.

### FIELD OF THE INVENTION

The present invention pertains to methods and apparatus for providing voice communications over conventional telephone networks. More particularly, one embodiment of the present invention provides for a payment to callers for every minute of phone calls that are placed within the United States at any time of day. Brief commercial messages are also provided, and may be prompted by the detection of key words spoken during these phone conversations.

### BACKGROUND OF THE INVENTION

When a telephone call is initiated using a conventional telephone, a phone company customer picks up the handset on his ordinary telephone, and dials the number of the person to whom he wishes to speak. When the handset is lifted or a button on the phone is depressed, a circuit is established between the caller's phone and the switch at the local telephone company. The switch routes the call using the number dialed by the caller, and a continuous circuit is then provided between the caller and the recipient of the call. The same basic procedure is employed for either local or long distance calls.

Even after several years of steep discounting, long distance calling can still be very expensive. In the past few years, several companies have inaugurated “Internet telephony” using software installed on a sending and receiving pair of personal computers, or using one personal computer and a particular website. One company which offers free long distance phone calls within the United States using a single personal computer is dialpad.com^{SM}.

This service is generally limited by the fact that both the caller and the intended recipient must use a personal computer which is connected to the Internet to place a call. The quality of voice communications using these services is also often impaired by the limited bandwidth and modem speed that are available for these kinds of connections. None of the previous systems offers a means for placing and receiving voice calls without using a personal computer or a website, or without paying relatively expensive toll charges. The development of a convenient, financially advantageous system for placing calls would constitute a major technological advance, and would satisfy long felt needs and aspirations in the telecommunications industry.

### SUMMARY OF THE INVENTION

The Cash Calling System provides methods and apparatus for enabling voice communications using conventional telephone networks or the Internet. Other embodiments may employ other networks, or may famish other communications services.

In one embodiment of the invention, a caller initiates a call by lifting a handset and dialing a special telephone number. He or she is automatically connected to a Call Routing Server through the local telephone company. After the Call Routing Server verifies that the caller's account is in good standing, the caller is connected to the intended recipient of the phone call. For every minute the caller is connected, the Call Routing Server credits his account with a payment. In one embodiment of the invention, the payment is one cent per minute.

In another embodiment of the invention, a Speech Recognition Engine which is connected to the line over which the call is placed is capable of detecting specific key words spoken by the parties on the call. A sponsor is able to purchase these key words for specific periods of time. When the sponsor's key words are detected, these occurrences may be compiled and analyzed using “data-mining” techniques. The sponsor may also purchase the automatic deployment of particular advertising messages which may be presented to the callers whenever the sponsor's key words are spoken.

In an alternative embodiment of the invention, the caller's phone call may automatically initiate a connection to a local Internet Service Provider (ISP). The ISP then uses the phone number which he dialed to find another, remote Internet Service Provider somewhere on the Internet. The caller's voice is converted to a digital signal, and is routed via the first, and then to the second Internet Service Provider, where the digital signal is converted back to audio. This audio signal is conveyed to the intended recipient of the call when the second, remote Internet Service Provider places a local call to the recipient's ordinary telephone using the conventional local telephone system.

An appreciation of the other aims and objectives of the present invention and a more complete and comprehensive understanding of this invention may be obtained by studying the following description of a preferred embodiment, and by referring to the accompanying drawings.

### A BRIEF DESCRIPTION OF THE DRAWINGS

FIG. 1 is a diagram which shows one of the preferred embodiments of the invention.

FIGS. 2 and 3 are diagrams which illustrate the “Voxmining^{SM}” and “Precision Promotion Deployment^{SM}” features offered by the present invention.

### A DETAILED DESCRIPTION OF PREFERRED & ALTERNATIVE EMBODIMENTS

I. A Preferred Embodiment of the Invention

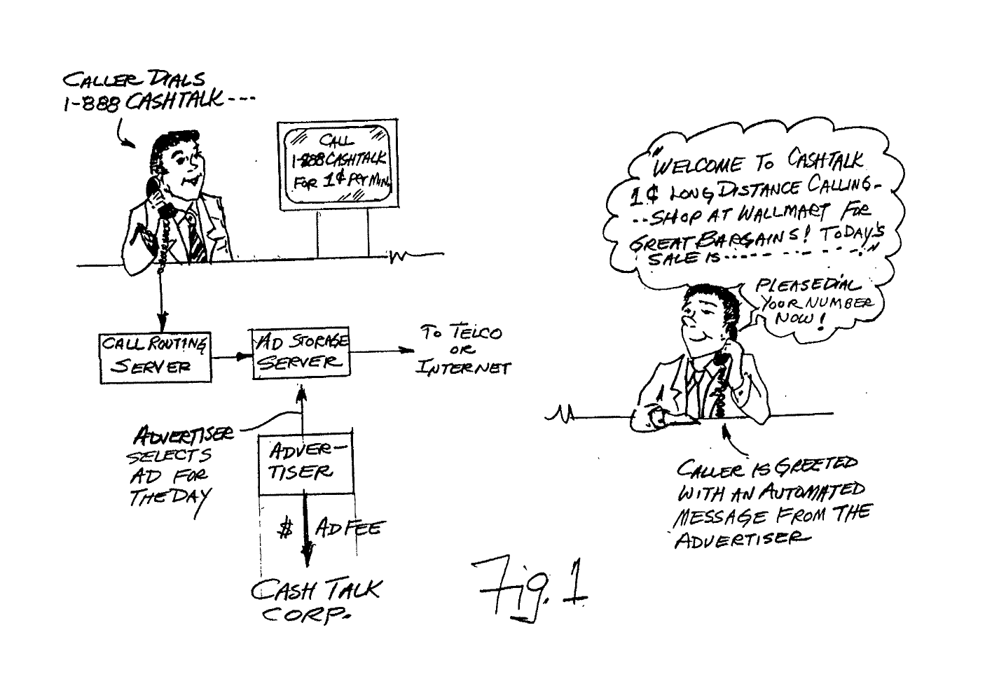

The present invention comprises methods and apparatus for making phone calls using conventional telephone networks, the Internet or other systems. FIG. 1 portrays a caller responding to a promotion for a new telephone service called “Cash Talk^{SM}.” The caller dials a special toll-free number, and is connected to a central computer, or Call Routing Server, which identifies the caller. The Call Routing Server prompts the caller to dial a telephone number, and the call is then placed to the intended recipient of the call. The call may be routed over a conventional telephone network, through the Internet or over some other connection.

During the phone call, brief commercial audio messages may be played on behalf of a sponsor. These messages may be stored on an Ad Storage Server connected to the Call Routing Server.

The Call Routing Server issues a payment or credit to the caller for every minute a conversation is maintained by the parties of the phone call. This payment or credit may be in the form of a check, a credit to a credit card account, a credit for some other services received, or in coupons that may be redeemed for goods or services provided by a sponsor. In one preferred embodiment of the invention, the payment is issued at the rate of one cent per minute.

II. An Alternative Embodiment of the Invention

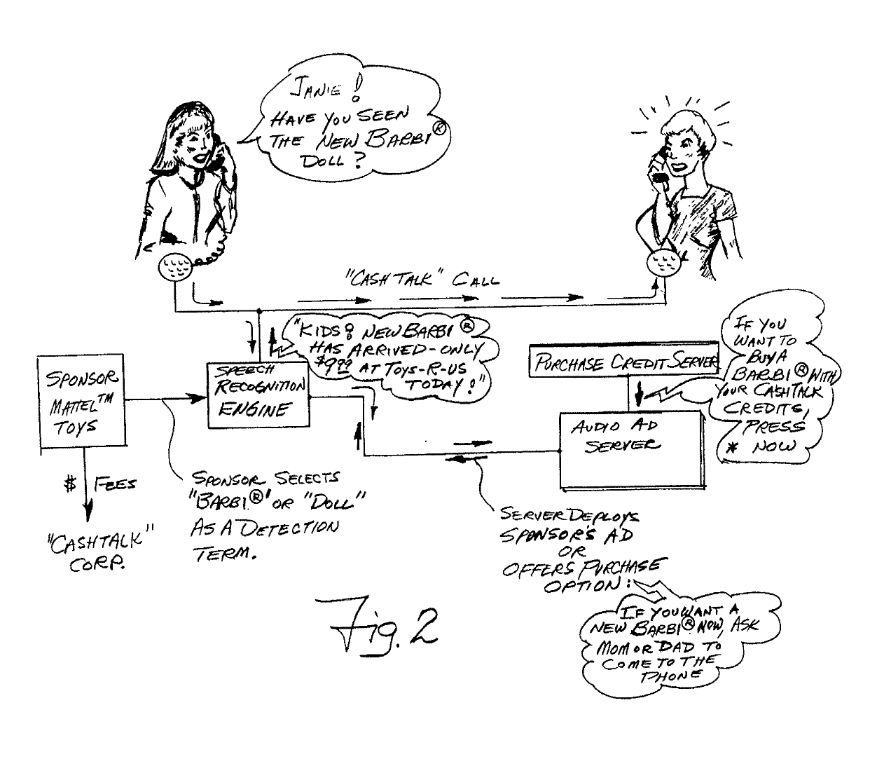

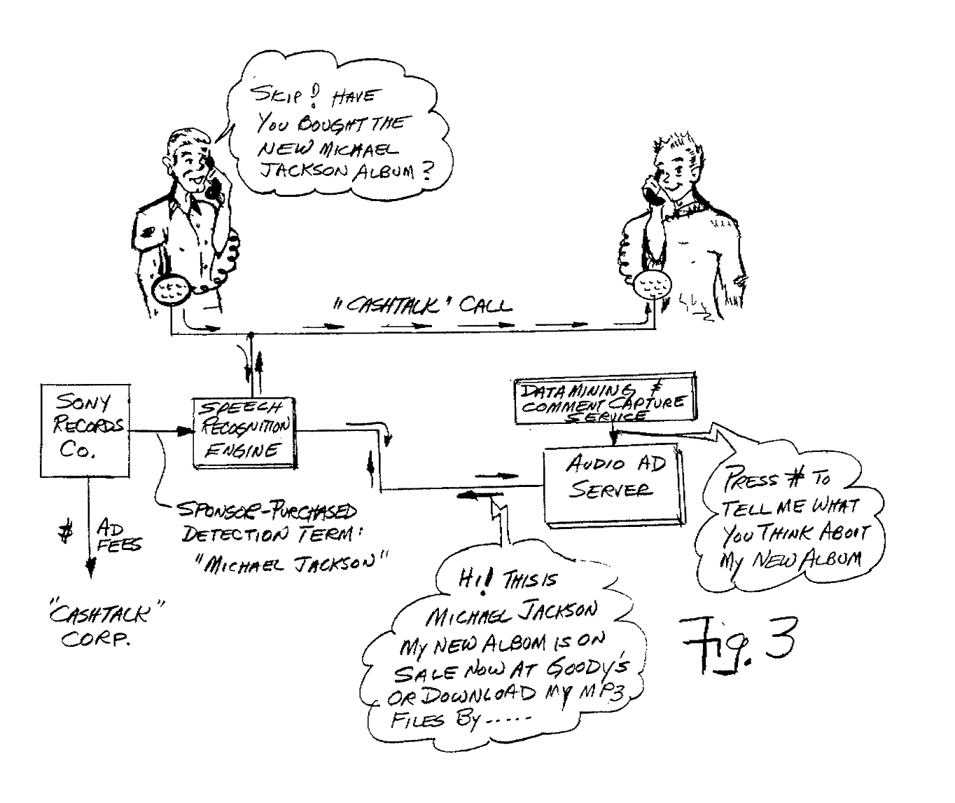

FIGS. 2 and 3 depict the novel “voxmining” and “precision promotion deployment” features offered by the present invention. A Speech Recognition Engine connected to the line which carries the call placed using the Cash Talk^{SM} Service may be programmed to detect specific key words which are spoken by the parties participating in the call. A sponsor may purchase “detection opportunities” for a specified period of time. When these words or phrases, are spoken and detected by the Speech Recognition Engine, these occurrences may be compiled and analyzed using “data-mining” techniques. In this Specification and in the claims that follow, the term “key words” is intended to encompass any spoken word, phrase, sound or utterance; or any other sensible audio emanation.

The sponsor may also purchase a precision promotion deployment which causes the Ad Storage Server to deploy a targeted advertisement whenever the key words are spoken. In an alternative embodiment of the invention, the detection process may be expanded to sensing or detecting a pattern in a stream of data. Any pattern, similar pattern, or groups of characters, alpha-numerical symbols or values, or data bits may be sensed and/or analyzed. The invention may also be extended to the collection of information for polling purposes such as political campaigns.

Unlike conventional broadcast or print media advertising, which involves a one-way transmission of ads, the present invention furnishes a direct connection between a customer's frame of mind, and the deployment of a promotional message that is precisely aimed at that frame of mind. Unlike conventional advertising, where a sponsor is left to speculate about the effectiveness of an expensive broadcast or print campaign, the present invention offers an empirically verifiable method of precise marketing processes.

The present invention offers a revolutionary new form of advertising, which offers empirical evidence of the efficacy of an advertising campaign. The invention also furnishes a method for recording and then analyzing recorded data concerning a caller's frame of mind, or his or her responses to an advertisement or to other campaign information. This information may be combined with data about the phone call such as location of call origination or time of day, to supply a database of demographic information. The deployed promotion may include an offer to purchase goods or services, or may provide an opportunity for a caller to obtain information associated with said spoken keyword or to collect comments associated with particular goods or services. This feature may also be extended to the collection of information for political polling. The Ad Storage Server may also be configured to automatically alter the deployment of the precisely targeting promotion in response to recognized trends in the detection of said spoken keyword.

In yet another embodiment of the invention, human operators may be utilized to detect spoken keywords.

### CONCLUSION

Although the present invention has been described in detail with reference to one or more preferred embodiments, persons possessing ordinary skill in the art to which this invention pertains will appreciate that various modifications and enhancements maybe made without departing from the spirit and scope of the claims that follow. The various alternatives for providing voice communications that have been disclosed above are intended to educate the reader about preferred embodiments of the invention, and are not intended to constrain the limits of the invention or the scope of claims.

What is claimed is:

1. A method comprising the steps of:
providing a voice communication over a conventional telephone network; and
making a payment to a caller for placing a call.

2. A method as recited in claim 1, in which said payment is in the form of cash.

3. A method as recited in claim 1, in which said payment is in the form of a credit.

4. A method as recited in claim 1, in which said payment is in the form of a coupon.

5. An apparatus comprising:
a network;
a first voice terminal; and
a second voice terminal;
a server;
said server being used to connect said first voice terminal to said second voice terminal;
said server including software;
said software being used to issue credits to callers for placing calls.

6. A propagated signal comprising:
an emanation issued from a central computer;
said emanation generated by software running on said central computer;
said emanation being used to furnish a credit to a caller for placing a call.

7. A method comprising the steps of:
detecting a frame of mind of a consumer;
presenting a precisely targeting promotion to said consumer that is triggered by the detection of said frame of mind.

8. A method as recited in claim 7, in which said frame of mind of a consumer is detected by sensing a spoken keyword using a speech recognition engine.

9. A method as recited in claim 7, in which said frame of mind of a consumer is recorded to provide empirical evidence of the effectiveness of an advertising campaign.

10. A method as recited in claim 7, in which said frame of mind of a consumer is recorded and then analyzed to provide a sponsor with marketing information.

11. A method as recited in claim 7, in which said frame of mind of a consumer is recorded, analyzed and then combined with call data to provide a sponsor with demographic information.

12. A method as recited in claim 8, in which said precisely targeting promotion includes an offer to purchase specific goods associated with said spoken keyword.

13. A method as recited in claim 8, in which said precisely targeting promotion includes an offer to purchase specific services associated with said spoken keyword.

14. A method as recited in claim 8, in which said precisely targeting promotion includes an offer to obtain information associated with said spoken keyword.

15. A method as recited in claim 8, in which said precisely targeting promotion includes an offer to allow specific comments associated with said spoken keyword to be recorded.

16. A method as recited in claim 8, in which the deployment of said precisely targeting promotion is automatically altered in response to recognized trends in the detection of said spoken keyword.

17. A method as recited in claim 7, in which said frame of mind of a consumer is detected regarding a political campaign.

18. A method as recited in claim 7, in which said precisely targeting promotion that is triggered by the detection of said frame of mind pertains to a political campaign.
